(19) United States
(12) Patent Application Publication
(10) Pub. No.: US 2023/0365002 A1
(43) Pub. Date: Nov. 16, 2023

(54) CONTROL APPARATUS

(71) Applicant: DENSO CORPORATION, Kariya-city (JP)

(72) Inventors: Haibo LIU, Kariya-city (JP); Keisuke KAWAI, Kariya-city (JP); Akira SAKAMOTO, Kariya-city (JP); Tatsuya TAKAGI, Kariya-city (JP); Shigeru KAMIO, Kariya-city (JP)

(73) Assignee: DENSO CORPORATION, Kariya-city (JP)

(21) Appl. No.: 18/224,177

(22) Filed: Jul. 20, 2023

Related U.S. Application Data
(63) Continuation of application No. PCT/JP2021/048804, filed on Dec. 28, 2021.

(30) Foreign Application Priority Data
Jan. 22, 2021 (JP) 2021-009120

(51) Int. Cl. B60L 15/20

(52) U.S. Cl. CPC B60L 15/20

(57) ABSTRACT

A control apparatus includes an operation control unit; a first torque command value setting unit that sets a required torque command value; a second torque command value setting unit that sets a vehicle-stop torque command value; and a waveform setting unit that sets a torque waveform. The operation control unit controls the output torque of the rotary electric machine along the torque waveform when changing the output torque of the rotary electric machine. The waveform setting unit utilizes a first torque waveform and subsequently utilizes a second torque waveform as the torque waveform, the first torque waveform being capable of attenuating a vibration of the vehicle in a pitch direction, the second torque waveform being capable of suppressing a vibration in a power transmission member provided in a power transmission system for transmitting a torque of the rotary is electric machine to wheels.

### CROSS-REFERENCE TO RELATED APPLICATIONS

This application is the U.S. bypass application of International Application No. PCT/JP2021/048804 filed on Dec. 28, 2021, which designated the U.S. and claims priority to Japanese Patent Application No. 2021-009120 filed on Jan. 22, 2021, the contents of which is incorporated herein by reference.

### BACKGROUND

### Technical Field

The present disclosure relates to a control apparatus of a vehicle.

### Description of the Related Art

Conventionally, a vehicle such as an electric vehicle provided with a rotary electric machine as a power source for travelling is known. A rotary electric machine used for such a vehicle is referred to as a motor generator capable of performing a driving operation and a regenerative operation. In such a vehicle, a braking force is produced when the rotary electric machine performs a regenerative operation, whereby the vehicle is able to decelerate. For example, a control apparatus is mounted on a vehicle provided with such a rotary electric machine in which an amount of regeneration of the rotary electric machine is adjusted, thereby adjusting the braking force of the vehicle.

### SUMMARY

According to the present disclosure, a control apparatus capable of causing a vehicle to appropriately stop is provided. As a first aspect of the present disclosure, a control apparatus is provided including an operation control unit; a first torque command value setting unit that sets a required torque command value; a second torque command value setting unit that sets a vehicle-stop torque command value; and a waveform setting unit that sets a torque waveform.

### BRIEF DESCRIPTION OF THE DRAWINGS

FIG. 1 is a block diagram showing an overall configuration of a vehicle according to an embodiment;

FIG. 2 is a block diagram showing an electrical configuration of a vehicle according to the embodiment;

FIG. 3 is a timing diagram in which timings (A) and (B) show a change in a vehicle speed and a change in a brake driving force torque of a rotary electric machine according to reference example;

FIG. 4 is a flowchart showing processes executed by the embodiment;

FIG. 5 is a flowchart showing processes executed by the embodiment;

FIG. 6 is a timing diagram in which respective timings (A) to (F) show changes in respective parameters of the vehicle according to the embodiment, including a regeneration torque command Tr, a required torque command TA, an output torque of a rotary electric machine, a hydraulic pressure of a braking apparatus and an acceleration factor in the pitch direction of the vehicle; and

FIG. 7 is a timing diagram in which respective timings (A) to (C) show changes in respective parameters of the vehicle according to the embodiment, including a vehicle speed V, an output torque of the rotary electric machine and a change in the acceleration factor in the pitch direction of the vehicle.

### DETAILED DESCRIPTION OF THE PREFERRED EMBODIMENTS

Conventionally, a vehicle such as an electric vehicle provided with a rotary electric machine as a power source for travelling is known. A rotary electric machine used for such a vehicle is referred to as a motor generator capable of performing a driving operation and a regenerative operation. In such a vehicle, a braking force is produced when the rotary electric machine performs a regenerative operation, whereby the vehicle is able to decelerate. A control apparatus disclosed by JP-A-2013-158178 is mounted on a vehicle provided with such a rotary electric machine in which an amount of regeneration of the rotary electric machine is adjusted, thereby adjusting the braking force of the vehicle.

An amount of braking force produced by a regenerative operation of a rotary electric machine is generally set depending on an operation quantity of the driver. However, when stopping the vehicle, in the case where a braking force is continuously produced depending on the operation quantity of the brake until the vehicle stops, it is possible that the vehicle significantly vibrates in the longitudinal direction after stopping the vehicle, that is, the vehicle possibly vibrates significantly in the pitch direction. This is because, some members such as a drive shaft provided in a power transmission system to transmit the torque of the rotary electric machine to the wheels has a torsion, and the torsion in the drive shaft is released due to the vehicle stop, thereby causing the vibration of the vehicle. A vibration of the vehicle in the pitch direction when stopping the vehicle may cause discomfort to passengers in the vehicle.

As a countermeasure for that vibration, for example, similar to a control apparatus disclosed in the above-mentioned PTL1, the regenerative amount of the rotary electric machine may be lowered as the vehicle speed decreases when the vehicle is stopping. However, with only restricting the regenerative among depending on the vehicle speed, it is difficult to suppress the vibration in the pitch direction of the vehicle when the vehicle is stopping. For example, when a braking operation is activated in a low-speed travelling, since the vehicle speed rapidly decreases, it is difficult to change the regenerative amount to follow the change in the vehicle speed. As a result, a vibration in the pitch direction of the vehicle when stopping may not be suppressed. Further, depending on an adjusting manner of the braking force produced by the rotary electric machine, passengers may suffer a discomfort due to so-called ‘Missing G’ and feel that the vehicle has insufficient deceleration. In this regard, further improvement is required for the method of stopping the vehicle using the braking force of the rotary electric machine.

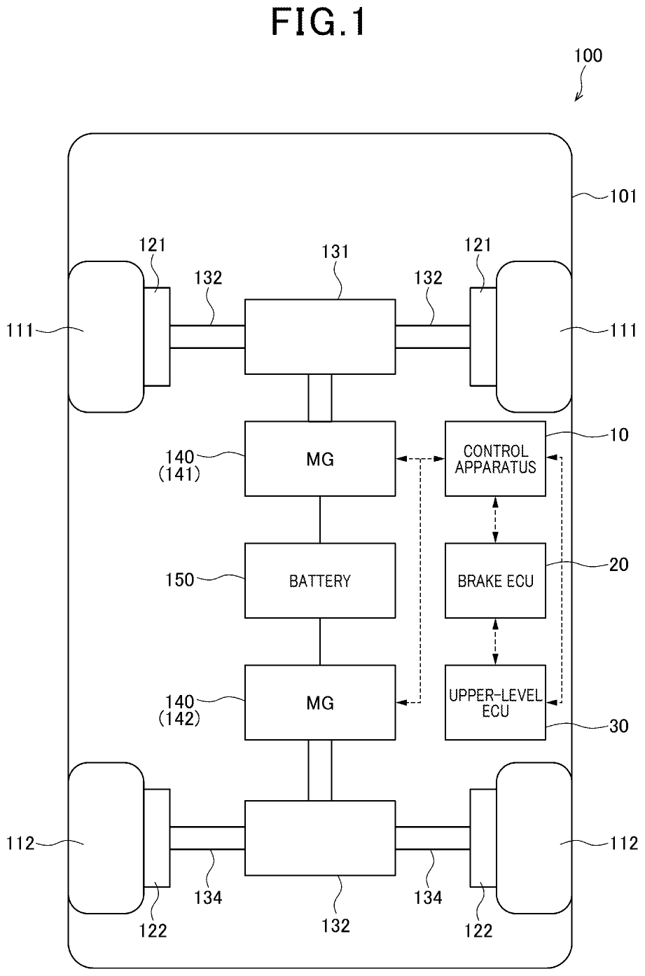

Hereinafter, with reference to the drawings, embodiments of the present embodiment will be described. In order to facilitate understanding of the description, the same reference numerals are applied as much as possible to the same constituents in the respective drawings and redundant explanation will be omitted. Firstly, an overall configuration of the vehicle to which a control apparatus of the present embodiment is mounted will be described. As shown in FIG. 1, a vehicle 100 is provided with a vehicle body 101, wheels 111 and 112, rotary electric machines 141, 142 and a battery 150.

The vehicle body 101 is a main body of the vehicle 100 and is generally referred to as body. The wheels 111 is a pair of wheels provided on a front part of the vehicle body 101 and the wheels 112 is a pair of wheels provided on a rear part of the vehicle body 101. Thus, total 4 wheels are provided in the vehicle 100. For the vehicle 100 according to the present embodiment, all of 4 wheels 111 and 112 function as drive wheels, that is, so called four-wheel drive vehicle.

The rotary electric machine 141 produces, based on the power supplied from the battery 150, a torque for rotating the wheels 111, that is, a drive torque to cause the vehicle 100 to travel. The rotary electric machine 141 is configured as a so-called motor generator (MG). The torque produced by the rotary electric machine 141 is transmitted to the respective wheels 111 via the power train part 131 and the drive shaft 133 to rotate the wheels 111. Note that the power exchanged between the battery 150 and the rotary electric machine 141 is performed by an inverter as a power converter. In FIG. 1, illustration of the inverter is omitted.

The rotary electric machine 142 produces a drive torque based on the power supplied from the battery 150, thereby rotating the respective wheels via the power train part 132 and the drive shaft 134. Since the rotary electric machine 142 has the same structure as that of the rotatory electric machine, detailed description will be omitted.

The rotary electric machines 141 and 142 also produce a braking torque that applies a braking force to the wheels 111 and 112 with the regenerative operation thereof. The braking torque applied to the wheels 111 and 112 from the rotary electric machines 141 and 142 is capable of causing the vehicle 100 to decelerate and stop. Hereinafter, a drive torque outputted from the rotary electric machine 141 for driving the vehicle 100 and a braking torque outputted from the rotary, electric machine 141 for braking the vehicle 100 are referred to as output torque. The output torque of the rotary electric machine capable of applying the driving force to the vehicle 100 is expressed by a positive value and the output torque of the rotary electric machine 140 capable of applying the braking force to the vehicle 100 is expressed by a negative value.

Thus, the vehicle 100 is an electric vehicle provided with 2 rotary electric machines 141 and 142 for a power source of the travelling. The control apparatus 10 simultaneously controls the respective rotary electric machines 141 and 142 with similar content of the control. Hence, in the following description, the rotary electric machine 141 and 142 are referred to as rotary electric machine 140. For example, the output torque of the rotary electric machine 140 refers to a total value of the output torque of the respective rotary electric machines 141 and 142.

Hereinafter, in the vehicle 100, a member provided in a power transmission system for transmitting the torque of the rotary electric machine 140 to the wheel 111 is also referred to as power transmission member. For example, the power transmission member includes a power train part 131, 132, and the drive shaft 133 and 134.

In the respective wheels 111, braking apparatuses 121 are provided. The braking apparatus 111 applies a braking force to the wheels 111 with a hydraulic pressure. Similarly, in the respective wheels 112, braking apparatuses 122 are provided. The braking of the vehicle 100 may be applied by the rotary electric machines 141 and 142 or may be applied by the braking apparatuses 121 and 122. According to the present embodiment, the braking of the vehicle 100 is performed by the rotary electric machine 140. The braking by the braking apparatuses 121 and 122 is supplementally performed as required.

The battery 150 is a storage battery for supplying power to the respective rotary electric machines 141 and 142. According to the present embodiment, a lithium-ion battery is used for the battery 150. In the vehicle 100, a brake ECU (electronic control unit) 20 and a upper-level ECU 30 are provided in addition to the control apparatus 10. The control apparatus 10, the brake ECU 20 and the upper-level ECU 30 are each mainly configured of a microcomputer including CPU, ROM and RAM, These units perform bi-directional communication via a network provided in the vehicle 100.

The brake ECU 20 controls the operations of the braking apparatuses 121 and 122 in accordance with a command transmitted from the upper-level ECU 30. The upper-level ECU 30 integrally controls overall operations of the vehicle 100. The upper-level ECU 30 executes necessary processes for controlling the vehicle 100 while performing bi-directional communication with each of the control apparatus 10 and the brake ECU 20.

The control unit 10, the brake ECU 20 and the upper-level ECU 30 may not be divided into 3 apparatuses like the present disclosure. For example, the control apparatus 10 may integrate functions of the brake ECU 20 and the upper-level ECU 30. The vehicle 100 is provided with a plurality of sensors for detecting various quantity states thereof.

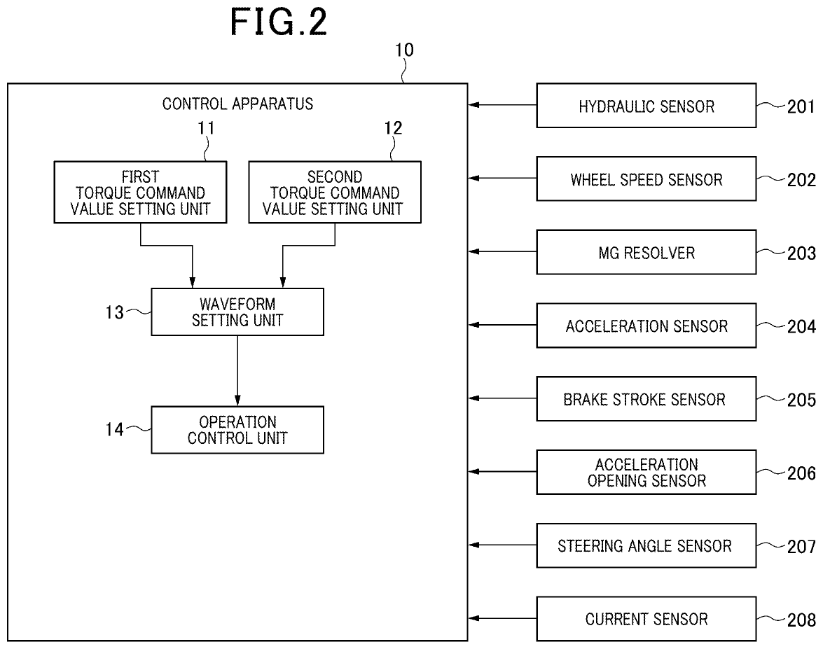

As shown in FIG. 2, such sensors include, for example, a hydraulic sensor 201, a wheel speed sensor 202, a MG resolver 203, an acceleration sensor 204, a brake stroke sensor 205, an accelerator opening sensor 206, a steering angle sensor 207 and a current sensor 208.

The hydraulic sensor 201 detects hydraulic pressures of the respective braking apparatuses 121 and 122. The hydraulic sensor 201 is individually provided for each of the braking apparatuses 121 and 122. However, in FIG. 2, the hydraulic sensor 201 is schematically illustrated as a single block. The signal indicating the hydraulic pressure detected by the hydraulic sensor 201 is transmitted to the control apparatus 10 via the brake ECU 20.

The wheel speed sensor 202 detects a rotation speed as the number of rotations per unit time of the wheels 111 and 112. The wheel speed sensor 202 is individually provided for each of the 4 wheels 111, 112. However, in FIG. 2, the wheel speed sensor 202 is schematically illustrated as a single block. The signal indicating the rotation speed of the wheels 111 and 112 detected by the wheel speed sensor 202 is transmitted to the control apparatus 10. The control apparatus 10 detects the travelling speed of the vehicle 100 based on the signal transmitted to the control apparatus.

The MG resolver 203 detects the rotation speed of the output shaft of the respective rotary electric machines 141 and 142. The MG resolver 203 is individually provided for each of the output shafts of the rotary electric machines 141 and 142. However, in FIG. 2, the MG resolver 203 is schematically illustrated as a single block. The signal indicating the rotation speed detected by the MG resolver 203 is transmitted to the control apparatus 10. The control apparatus 10 detects the travelling speed of the vehicle 100 based on the signal transmitted to the control apparatus 10.

The acceleration sensor 204 detects an acceleration factor of the vehicle 100. The acceleration sensor 204 is attached to the vehicle body 101. The acceleration sensor 204 is configured as a six axes sensor that detect the accelerations in the pitch direction, the roll direction and the yaw direction of the vehicle body 101 in addition to the accelerations in the longitudinal direction, the horizontal (width) direction and the vertical direction thereof. The signal indicating the respective accelerations detected by the acceleration sensor 204.

The brake stroke sensor 205 detects a depression amount of a brake pedal provided in a driver's seat of the vehicle 100. The signal indicating the depression amount detected by the brake stroke sensor 205 is transmitted to the control apparatus 10. The accelerator opening sensor 206 detects the depression amount of the brake pedal provided at the driver's seat of the vehicle 100. The signal indicating the depression amount detected by the accelerator opening sensor 206 is transmitted to the control apparatus 10.

The steering angle sensor 207 detects the steering angle of a rotation speed of the steering provided in the driver's seat of the vehicle 100. The signal indicating the steering angle detected by the steering angle sensor 207 is transmitted to the control apparatus 10. The current sensor 208 detects the drive current values transmitted to respective rotary electric machines 141 and 142. The current sensor 208 is individually provided one by one for each of the rotary electric machines 141 and 142. However, in FIG. 2, the current sensor 208 is schematically illustrated as a single block. The signal indicating the drive current values detected by the current sensor 208 is transmitted to the control apparatus 10.

As shown in FIG. 2, the control apparatus 10 is provided with, as functional elements thereof, an operation control unit 14, a first torque command value setting unit 11, a second torque value setting unit 12 and a waveform setting unit 13. The operation control unit 14 controls an operation of the rotary electric machine 140. The operation control unit 14 is able to individually control the output torque of respective rotary electric machines 141 and 142. However, according to the present embodiment, a case will be described in which the respective rotary electric machines 141 and 142 output the same torque. The operation control apparatus 14 controls the output torque of the rotary electric machine 14 to be the torque command value which is set by the first torque command value setting unit 11 and the second torque command value.

The first torque command value setting unit 11 sets the required torque command value TA. The required torque command value TA is a target value of the brake driving force torque to be outputted by the rotary electric machine 140 based on an operation of the driver to the vehicle 100, for example, an operation of the brake pedal or an operation of the acceleration pedal. The second torque command value setting unit 12 sets a vehicle-stop torque command value TB. The vehicle-stop torque command value TB is a target value of the torque to be outputted by the rotary electric machine 140 to maintain the stop-state of the vehicle 100 without using the braking apparatuses 121 and 122 when the vehicle 100 stops.

The waveform setting unit 13 sets the torque waveform. The torque waveform indicates a change in the target value of the torque to be outputted from the rotary electric machine 140 with respect to time, when the output torque of the rotary electric machine 140 is caused to change from the required torque command value TA to the vehicle-stop torque command value TB. The operation control unit 14 controls the output torque of rotary electric machine 140 to be the required torque command value TA. On the other hand, when a travelling vehicle stops, the operation control unit 14 performs a process for changing, along the torque waveform, the output torque of the rotary electric machine 140 to be the vehicle-stop torque command value TB from the required torque command value TA, thereby stopping the vehicle 100. Hereinafter, a control of the output torque of the rotary electric machine 140 using the torque waveform is also referred to torque waveform control.

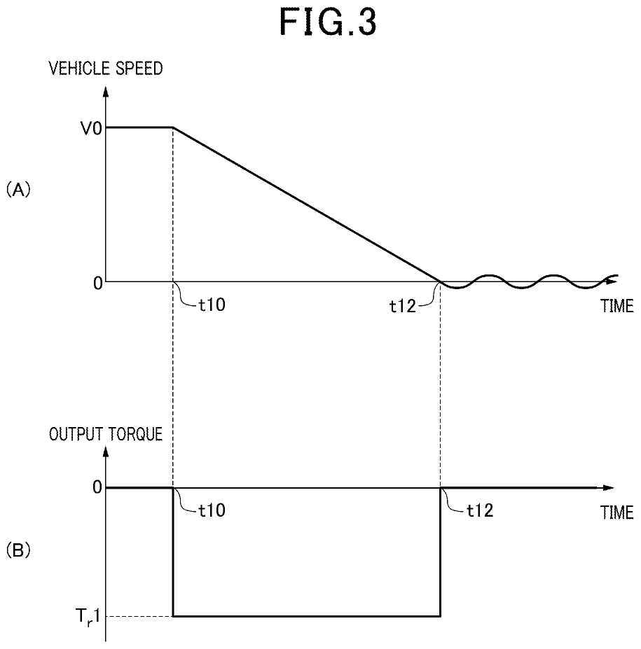

Firstly, with reference to FIG. 3, an example will be described in which the vehicle 100 is caused to stop without performing the torque waveform control. In FIG. 3, a comparative example is shown in which a control apparatus performs a control to stop the vehicle 100. The timing (A) of FIG. 3 exemplifies a change in the travelling speed of the vehicle 100. The timing (B) of FIG. 3 exemplifies a change in the output torque of the rotary electric machine 140.

In the example shown in FIG. 3, the vehicle 100 travels at a constant speed V0 until time t10. In the timing (B) of FIG. 3, the output torque of the rotary electric machine 140 in this period shows 0. After time t10, since the driver depresses the brake pedal, the output torque value of the rotary electric machine 140 shows a negative value Tr1. As shown in the timing (A) of FIG. 3, after time t10, the traveling speed of the vehicle 100 gradually decreases and reaches 0 at time t12. Assuming that the amount of depression of the brake pedal is constant, an amount of output torque of the rotary electric machine 140 in this comparative example is constant value of Tr1 until time t12 at which the vehicle 100 stops.

In a period where the vehicle 100 is in a deceleration travelling, that is, in a period from time t10 to time t12, a torsion has occurred in the power transmission members provided from the rotary electric machine 140 to the wheels 111 and 112. Thereafter, when the vehicle 100 stops at time t12, the torsion of the power transmission members is released. In other words, the power transmission tends to resume previous state. With this behavior, as shown in the timing (A) of FIG. 3, the vehicle body 101 possibly vibrates in the pitch direction after time t12. Since such a vibration may cause discomfort to the passengers in the vehicle 10, which is unfavorable.

In this respect, according to the control apparatus 10 of the present disclosure, the output torque of the rotary electric machine 140 is controlled using the torque wave set by the waveform setting unit 13 when the vehicle 100 stops, suppressing vibrations of the vehicle 100 as described above. Specifically, the control apparatus 10 executes a torque waveform control process in which the output torque value of the rotary electric machine 140 is caused to be changed from the required torque command value to the vehicle-stop torque command value TB along the torque waveform. Thus, the output torque of the rotary electric machine 140 does not rapidly change but gradually change with time from the required torque command value to the vehicle-stop torque command value TB. Therefore, the power transmission members at which a torsion has occurred due to the braking goes back to the previous state. In other words, the torque waveform is set in advance as an appropriate waveform such that the torsion occurring in the power transmission members goes back to the previous state. The torque waveform of the present disclosure is generated as a so-called first order lag system. When the output torque of the rotary electric machine 140 changes to the vehicle-stop torque command value TB, the vehicle 100 becomes in a stopped state. In this state, since the torsion occurred in the power transmission members are disappeared, vibrations of the vehicle body 101 shown in the timing (A) of FIG. 3 do not occur. Thus, according to the control apparatus 10 of the present embodiment, with the braking force of the rotary electric machine 140, the vehicle 100 can be appropriately stopped.

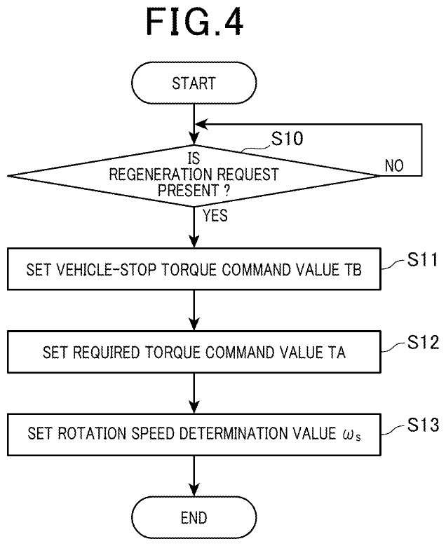

In order to achieve the above-described torque waveform control, detailed processes executed by the control apparatus 10 will be described. The series processes shown in FIG. 4 is executed by the control apparatus 10 when the vehicle 100 is required to stop. The processes shown in FIG. 4 may be repeatedly executed every time when a predetermined control period is elapsed.

The control apparatus 10 determines, as a process at step S10, whether a regeneration request is transmitted from the upper-level ECU 30. The regeneration request refers to a control signal transmitted to the control apparatus 10 from the upper-level EC 30 when a braking torque produced by a regeneration is required at the rotary electric machine 140. For example, in the case where the driver depresses the brake pedal for stopping the vehicle 100, the upper-level ECU 30 transmits the regeneration request to the control apparatus 10. The upper-level ECU 30 calculates, based on the depression amount of the brake peak detected by a brake stroke sensor 205, a regeneration torque value Tr using a formula or a map and the like. Also, the upper-level ECU 30 transmits the calculated regeneration torque command value Tr together with the regeneration request to the control apparatus 10. The regeneration torque command value Tr is a target value of a braking torque to be outputted from the rotary electric machine 140 by the regeneration.

When the regeneration request is not transmitted from the upper-level ECU 30, the control apparatus 10 performs a negative determination for the process at step S10 and repeatedly executes the determination process at step S10. When the upper-level ECU 30 transmits the regeneration request, the control apparatus 10 performs an affirmative determination for the process at step S10, to be affirmative and proceeds to step S11.

The control apparatus 10 performs, as a process at step S11, a process for setting the vehicle-stop torque command value TB with the second torque command value setting unit 12. As described above, the vehicle-stop torque command value TB refers to a target value of the brake driving torque to be outputted by the rotary electric machine 140 when the vehicle 100 stops. The second torque command value setting unit 12 according to the present embodiment sets the vehicle-stop torque command value TB as a torque to be outputted from the rotary electric machine 140 to maintain the stopped state after the vehicle 100 stops. For example, in the case where the output torque from the rotary electric machine 140 has been set as 0 when the vehicle 100 stops at a rise-gradient slope, the vehicle 100 possibly moves reversely due to the gravity. In this case, the second torque command value setting unit 12 sets the vehicle-stop torque command value TB to be larger than 0 as a target value of the torque to be outputted from the rotary electric machine 140 to maintain the stopped-state of the vehicle against the gravity.

For example, the second torque command value setting unit 12 calculates the vehicle-stop torque value TB based on a first deceleration of the vehicle 100 detected by the acceleration sensor 204 and a second deceleration of the vehicle 100 calculated from a rotation speed of the wheels 111 and 112 detected by the wheel speed sensor 202. The first deceleration contains actual deceleration factor of the vehicle 100 in the longitudinal direction of the vehicle 100 and a vehicle-travelling directional component of the gravitational acceleration. The second deceleration is actual deceleration factor of the vehicle 100 in the longitudinal direction thereof. Hence, a difference value between the first deceleration and the second deceleration is calculated, thereby obtaining the vehicle longitudinal direction component of the gravity acceleration. Utilizing this, the second torque value setting unit 12 calculates the difference value between the first deceleration and the second deceleration and calculates, from the calculated difference value, a deceleration force as the gravity component that influences the vehicle 100 in the longitudinal direction thereof when the vehicle 100 stops, using a known formula or the like. The second torque value setting unit 12 calculates the vehicle-stop torque command value TB from the calculated deceleration force, using a predetermined formula or the like.

The first deceleration detected by the acceleration 204 contains not only the actual deceleration of the vehicle 100 and the gravity acceleration in the longitudinal direction thereof, but also the deceleration produced in the vehicle 100 caused by turning of the vehicle 100. Hence, in order to calculate the vehicle-stop torque command value TB more accurately, the second torque command value setting unit 12 may exclude the torque corresponding to the deceleration produced in the vehicle 100 when turning, from the vehicle-stop torque command value TB. The turning resistance torque T_{gy} can be obtained based on the following formula f1 for example.

$$[ Math 1 ]$$

$${T}_{gy} = \frac{{mV}^{2} sin ( \frac{θ}{{K}_{h}} )}{L} \times {L}_{r} r \qquad ( f 1 )$$

In the formula f1, m refers to mass of the vehicle 100 and V refers to vehicle speed. θ refers to a steering angle detected by the steering angle sensor 207. Kₕ refers to a steering gear ratio. L refers to a wheelbase length of the vehicle 100, Lᵣ refers to a distance from the gravity center of the vehicle 100 to the axis of the wheel 112 rear wheels), and r refers to a radius of the wheels 111 and 112.

The control apparatus 10 executes a process of step S12 subsequent to step S11 for setting the required torque command value TA with the first torque command value setting unit 11. Specifically, the first torque command setting unit 11 calculates the drive torque command value based on the depression amount of the accelerator pedal detected by the accelerator opening sensor 206, using a formula, a map and the like. Then, the first torque command value setting unit 11 adds the calculated drive torque command value and the regeneration torque command value Tr included in the regeneration request which is transmitted from the upper-level ECU in the process at step S10, thereby setting the required torque command value TA.

When the vehicle 100 is caused to be stopped, since the driver does not depress the accelerator pedal, that is in a state where the depression amount of the accelerator pedal is 0, the drive torque command value is 0. Hence, the required torque value TA is set to be the same value as the regeneration torque command value Tr.

The control apparatus 10 executes a process of step S13 subsequent to step S12 for setting the rotation speed determination value ωs with the operation control unit 14. The rotation speed determination value (a s is to determine whether the rotation speed of the wheels 111 and 112 decreases to reach a rotation speed for activating a torque waveform control. The rotation speed determination value ωs can be calculated using the following formula f2 for example.

$$[ Math 2 ]$$

$${ω}_{s} = \frac{Δ {T}_{r} . {τ}_{0}}{{I}_{v}} \qquad ( f 2 )$$

In the formula f2, ΔTᵣ refers to a command torque differential value in which the vehicle-stop torque command value TB calculated in the process of step S11 is subtracted from the required torque command value TA calculated at step S12. Iᵥ refers to a value in which the mass of the vehicle body 101 is converted to an inertia value in a rotating system such as the wheels 111 and the like. The inertia Iᵥ can be calculated based on the mass m of the vehicle 100 and the radius r of the wheels 111 and 112, using a formula Iᵥ=mr² for example. τ₀ refers to a value set in advance as a time constant of the torque waveform of the first order lag system used for the torque waveform control. The time constant τ₀ of the torque waveform can be set in the following manner such that the passengers do not feel discomfort, for example.

When the time constant τ is set to he excessively large, it is possible that the period becomes longer from a time when the output torque of the rotary electric machine 140 starts to change along the torque waveform to a time when the output torque of the rotary electric machine 140 reaches the vehicle-stop torque command value TB. In this case, passengers may suffer a discomfort so-called ‘Missing G’ and feel that vehicle 100 has insufficient braking force. In order to minimize to cause such a Missing G felt by the driver, it is effective to set, the time constant τ of the torque waveform to be shorter than a pitch resonance period of the vehicle 100.

Note that the pitch resonance frequency fₚ of the vehicle 100 can be obtained with the following formula f3.

$$[ Math 3 ]$$

$${f}_{p} = \frac{1}{2 π} \sqrt{\frac{22.3 {gh}_{c}}{0.14 {L}_{t} \cdot L}} \qquad ( f 3 )$$

In the formula (3), g refers to the gravity acceleration, L refers to the length of the wheelbase of the vehicle 100, Lₜ is the total length of the vehicle body 101 and he refers to the height of the gravitational center. The pitch resonant period of the vehicle 100 is an inverse of the pitch resonant frequency fp calculated with the formula f4. Hence, it is preferable to set the time constant τ of the torque waveform to be a. value expressed by the following formula f4 in order to minimize to cause such a Missing G felt by the driver.

$$[ Math 4 ]$$

$$τ < \frac{1}{{f}_{p}} \qquad ( f 4 )$$

On the other hand, when the time constant τ of the torque waveform is set to be excessively small, the period becomes excessively short from a time when the output torque of the rotary electric machine 140 starts to change along the torque waveform to a time when the output torque of the rotary electric machine 140 reaches the vehicle-stop torque command value TB. That is, since the torsion of the power transmission member is rapidly released, a backlash occurs in the power transmission member, and the passengers may possibly feel an impact. Further, if the vehicle 100 stops without sufficiently releasing the torsion, the vehicle possibly vibrates accompanied with the release of the power transmission member after the vehicle stop. In this regard, the waveform setting unit 13 sets the time constant τ as a value that satisfies a condition expressed by the following formula f5.

$$[ Math 5 ]$$

$$\frac{Δ {T}_{{T}_{r}}}{{K}_{d} . τ} < {ω}_{α} [ rad / s ] \qquad ( f 5 )$$

In the formula 5, ΔTᵣ refers to a torque similar to that used in the formula f2, that is, a command torque differential value in which the vehicle-stop command value TB is subtracted from the required torque command value TA. K_{d} refers to a coefficient indicting a rigidity of the power transmission member, specifically refers to a rigidity of the drive shafts 133 and 134, or an equivalent rigidity of suspensions in the longitudinal direction. ω_{α} refers to a threshold of the rotation speed of the wheels 111 and 112 with which the backlash is unlikely to occur on the power transmission member. The rotation speed threshold ω_{α} is set to be 4.8 [rad/s], for example.

The following formula f6 can be derived from the above-described formula 5.

$$[ Math 6 ]$$

$$\frac{Δ {T}_{r}}{{ω}_{α}} < τ \qquad ( f 6 )$$

The time constant to of the above-formula f2 is determined in advance by experiment or the like to satisfy the above-formulas f4 and f6 and stored in a memory of the control apparatus 10. With such a time constant τ₀, the torque waveform is set. Hence, the torque waveform set in such a manner avoids so-called Missing G and the passenger is unlikely to feel an impact of a backlash.

For the time constant τ₀, instead of using a fixed value set in advance, the waveform setting unit 13 may set the time constant τ₀ to satisfy the above formulas f4 and f6. For example, the waveform setting unit 13 may set the time constant τ₀ at each time, based on a calculation value of the command torque differential value ΔTᵣ using the above formulas f4 and f6.

The operation control unit 14 calculates, at step S13 shown in FIG. 4, the rotation speed determination value ωs based on the command torque differential value ΔTᵣ and inertia. I_{V} in addition to the time constant to set as described above, using the above-formula f2. The rotation speed determination value ωs thus set is utilized so as to activate the torque waveform control at a time when the rotation speed of the wheels 111 and 112 reaches a value lower than the rotation speed determination value ωs. As a result, the vehicle speed 100 can be 0, that is, the vehicle 100 can be stopped, at a time when the output torque of the rotary electric machine 140 reaches the vehicle-stop torque command value TB.

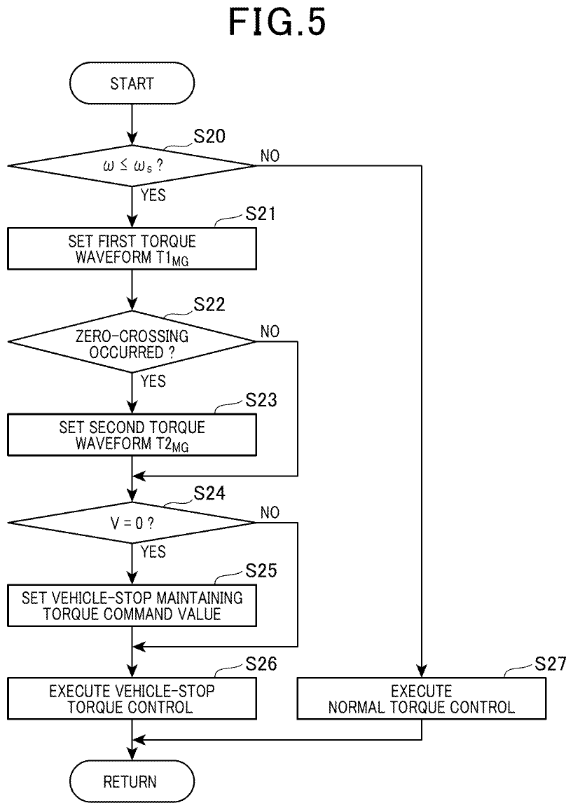

The control apparatus 10 repeatedly executes a series of processes shown in FIG. 5 at a predetermined period after completing the processes shown in FIG. 4. As shown in FIG. 5, as a process of step S20, the control apparatus 10 determines whether the rotation speed ω of the wheels 111 and 112 detected by the wheel speed sensor 202 is lower than or equal to the rotation speed determination value ωs set at the process of step S13 shown in FIG. 4. Specifically, the control apparatus 10 calculates an average value of the rotation speed of the wheels 111 and 112 detected by the wheel speed sensor 202 and determines whether the average value of the rotation speed is lower than or equal to the rotation speed determination value ωs. The control apparatus 10 may determine whether the average value of one wheel 111 is lower than or equal to the rotation speed determination value ωs in the process at step S20.

In an initial stage at which the braking torque is produced by the rotary electric machine 140 to stop the vehicle 100, in many cases, the rotation speed ω of the rotary electric machine 140 is larger than the rotation speed determination value ωs. Hence, the control apparatus 10 performs a negative determination for the process at step S20, and proceeds to step S27.

In the control apparatus 10, the operation control unit 14 executes a normal torque control as a process at step S27. The normal torque control refers to a control in which the output torque of the rotary electric machine 140 is caused to correspond to the required torque command value TA set at step S12 shown in FIG. 4. Hence, in the case where the operation control unit 14 executes the normal torque control, the output torque of the rotary electric machine 140 changes depending on the depression amount of the brake pedal. Specifically, the larger the depression amount of the brake pedal, the larger the braking torque is outputted from the rotary electric machine 140. The braking torque outputted from the rotary electric machine 140 applies the braking force to the vehicle 100, thereby decelerating the vehicle 100. That is, the rotation speed ω of the wheels 111 and 112 gradually, decreases.

Thereafter, when the rotation speed ω of the wheels 111 and 112 becomes a value lower than or equal to the rotation speed determination value ωs, the control apparatus 10 performs an affirmative determination for the process at step S20, and proceeds to step S21. Thus, the control apparatus 10 starts the torque waveform control. In the control apparatus 10, as a process at step S21, the waveform setting unit 13 performs a process for setting the first torque waveform. The first torque waveform is set to attenuate vibration in the pitch direction occurring on the vehicle 100 accompanied with the vehicle-stop. For example, the waveform setting unit 13 utilizes the following formula f7 to set the first torque waveform. Note that the formula f7 is defined by a Laplace transform.

$$[ Math 7 ]$$

$$T {1}_{MG} ( s ) = \frac{Δ {T}_{r}}{{τ}_{1} s + 1} G ( s ) \qquad ( f 7 )$$

The left side of the formula f7, T1_{MG}, is a function indicating a change in the torque command value of the rotary electric machine 140 with respect to time. The time-changing waveform indicated by the function T1_{MG} corresponds to the first torque wave. Hereinafter, T1_{MG} of the formula f7 is referred to as first torque waveform T1_{MG}, where s is a differential operator.

In the left side of the formula f7, ΔTᵣ is the same as the command torque differential value ΔTᵣ in the formular f2, that is, a value in which the stop-vehicle torque command value TB calculated at step S11 shown in FIG. 4 is subtracted from the required torque command value TA calculated at step S12 shown in FIG. 4. τ₁ refers to a time constant which is set to satisfy the above-described formulas f4 and f6. G(s) refers to a transfer function capable of attenuating the vibration of the vehicle 100 in the pitch direction. The transfer function G(s) expressed by the following formula f8 for example.

$$[ Math 8 ]$$

$$G ( s ) = \frac{\frac{1}{{W}_{n}^{2}} S + \frac{2 ζ}{{W}_{n}} S + 1}{\frac{1}{{W}_{c}^{2}} {S}^{2} + \frac{2 {τ}_{c}}{{W}_{c}} S + 1} \qquad ( f 8 )$$

In the formula f8, Wₙ refers to an actual measurement value of a pitching resonant period of the vehicle 100, and ζ refers to an actual measurement value of the pitch attenuation coefficient. W_{c} refers to a target value of the pitching resonant period of the vehicle 100, and ζ_{c} refers to a target value of the pitch attenuation coefficient. The actual measurement value Wₙ of the pitching resonant period and the pitch attenuation coefficient are derived in advance with an experiment and the like, and stored in the memory of the control apparatus 10. The target value W_{c} of the pitching resonant period and the target value ζ_{c} of the pitch attenuation coefficient are defined in advance and stored in the memory of the control apparatus 10.

As shown in FIG. 5, in the control apparatus 10, as a process at step S22 subsequent to step S21, the waveform setting unit 13 determines whether a zero-cross occurs on the acceleration in the pitch direction of the vehicle 100 detected by the acceleration senor 204. The zero-cross refers to a phenomenon in which the acceleration of the vehicle 100 in the pitch direction changes from a positive value to a negative value at a predetermined gradient or a phenomenon in which the acceleration of the vehicle 100 in the pitch direction changes from a negative value to a positive value at a predetermined gradient.

In the case where the vehicle 100 is decelerating, since the acceleration of the vehicle 100 in the pitch direction is maintained at 0 or around 0, the waveform setting unit 13 performs a negative determination for the process at step S22. In this case, as a process at step S24, the waveform setting unit 13 calculates the vehicle speed V as a travelling speed of the vehicle 100 based on the rotation speed of the wheels 111 and 112 detected by the wheel-speed sensor 202, and determines whether the calculated vehicle speed V is 0. When the vehicle 100 decelerates, since the vehicle speed V is not 0, the waveform setting unit 13 performs a negative determination at step S24. In this case, in the control apparatus 10, as a process at step S26, the operation control unit 14 executes the vehicle-stop torque control. Specifically, the operation control unit 14 executes a process for controlling the output torque of the rotary electric machine 140 to track the first torque waveform T1_{MG} shown in the formular f7. Thus, after executing the process at step S26, the control apparatus 10 temporarily terminates the processes shown in FIG. 5 and re-starts the processes shown in FIG. 5 at a time when a predetermined period elapses. Thereafter, the control apparatus 10 performs a negative determination at step S22 and repeatedly executes a process at step S26 based on the first torque waveform T1_{MG} in a period where the negative determination at step S24 continues.

The process at step S26 is repeatedly executed, thereby controlling the output torque of the rotary electric machine 140 to track the first torque waveform T1_{MG}. With this control, the torsion of the power transmission members goes back to the previous state. With this torsion of the power transmission members going back to the previous state, the vehicle body 101 vibrates in the pitch direction. Thus, a zero-crossing of the acceleration of the vehicle 100 occurs, in the pitch direction.

Since zero-cross occurs on the acceleration of the vehicle 100 in the pitch direction, the waveform setting unit 13 performs an affirmative determination at step S22. Thus, the waveform setting unit 13 performs a process for setting the second torque waveform as a process at step S23. The second torque waveform is set to attenuate a vibration occurring in the power transmission members of the vehicle 100 when the vehicle stops. The waveform setting unit 13 sets the second torque waveform using the following formula f9 for example.

$$[ Math 9 ]$$

$$T {2}_{MG} = Δ {T}_{C} {e}^{- \frac{t}{{τ}_{2}}} \qquad ( f 9 )$$

The left side of the formula 9 is a function indicating a change in the torque command value of the rotary electric machine 140 with respect to time. A time changing waveform indicated by the function T2_{MG} corresponds to the second torque waveform. Hereinafter, in the right side of the formula f9, ΔT_{C} is value in which the vehicle-stop torque command value TB is subtracted from the value of the first torque waveform T1_{MG} at a time when a zero-cross occurs on the acceleration of the vehicle 100 in the pitch direction. t refers to an elapsed time from a time when the process at step S23 is started to execute. τ₂ refers to a time constant. The waveform setting unit 13 sets the time constant τ₂ as shown in the following formula f10 for example.

$$[ Math 10 ]$$

$${τ}_{2} = \frac{{τ}_{0} - {τ}_{1} + \frac{2 ζ}{{W}_{n}} - \frac{2 {ξ}_{c}}{{W}_{c}}}{2} \qquad ( f 10 )$$

In the formula f10, the time constant τ₀ and τ₁ are similar to those used in the formulas f2 and f7. Further, the actual measurement value ζ of the pitch attenuation coefficient, the actual measurement value Wₙ of the pitching resonant period of the vehicle 100, the target values ζ_{c} of the pitch attenuation coefficient and the target value W_{c} of the pitching resonant period of the vehicle 100 are similar to those used in the formula f8.

As a process of step S24 subsequent to step S23, the waveform setting unit 13 determines whether the vehicle speed V is 0. At a time when execution of the process of step S23 is started , the vehicle 10 is decelerating. Hence, the waveform setting unit 13 performs a negative determination at step S24. In this case, in the waveform setting unit 13, the operation control unit 14 executes a vehicle-stop torque control as a process at step S26. Specifically, the operation control unit 14 executes a process for controlling the output torque of the rotary electric machine 140 to track the second torque waveform T2_{MG} shown in the formular f9. Thus, after executing the process at step S26, the control apparatus 10 temporarily terminates the processes shown in FIG. 5 and re-starts the processes shown in FIG. 5 at a time when a predetermined period elapses. Hereinafter, the control apparatus 10 repeatedly executes the process at step S26 based on the second torque waveform T2_{MG}, during a period where determination at step S22 is positive and the determination at step S24 is negative. to The process at step S26 is repeatedly executed, whereby the output torque of the rotary electric machine 140 is controlled to track the second torque waveform T2_{MG}. Thus, the output torque of the rotary electric machine 140 changes towards the vehicle-stop torque command value TB, while suppressing a vibration in the power transmission system.

Thereafter, the vehicle-speed V becomes 0, the waveform setting unit 13 performs a positive determination at step S24. In this case, the waveform setting unit 13 sets a vehicle-stop maintaining torque command value TC as a process at step S25. The vehicle-stop maintaining torque command value TC refers to a target value of the torque to be outputted from the rotary electric machine to maintain the vehicle 100 to be in a stopped-state. In the process at step S25, the waveform setting unit 13 basically utilizes the vehicle-stop torque command value TB set by the process at step S11 shown in FIG. 4 to be the vehicle-stop maintaining torque command value TC.

However, when an error is present in the vehicle-stop torque command value TB, if the output torque of the rotary electric machine 140 is controlled using the vehicle-stop torque command value TB, it is possible that the vehicle 100 cannot be maintained at the stopped-state. Hence, when determined that the vehicle 100 cannot be maintained at the stopped state even when changing the output torque of the rotary electric machine 140 towards the vehicle-stop command value TB to be along the second torque waveform T2_{MG}, the waveform setting unit 13 adjusts the second torque waveform T2_{MG} to maintain the vehicle 100 to be in the stopped state, while controlling the second torque waveform T2_{MG} such that a predetermined torque to be added thereto or subtracted therefrom. In this case, the waveform setting unit 13 sets the vehicle-stop maintaining torque command value TC based on the adjusted second torque waveform T2_{MG} at a time when the vehicle speed V becomes 0.

In the control apparatus 10, the operation control unit 14 executes the vehicle-stop torque control subsequent to the process at step S25. Specifically, the operation control unit 14 controls the output torque of the rotary electric machine 140 to be the vehicle-stop maintaining torque value TC. Thus, in the case where the vehicle speed V becomes 0 on an uphill road or a downhill road for example, that is, even when the vehicle 100 stops, the vehicle 100 can be maintained at the stopped-state with the output torque of the rotary electric machine 140.

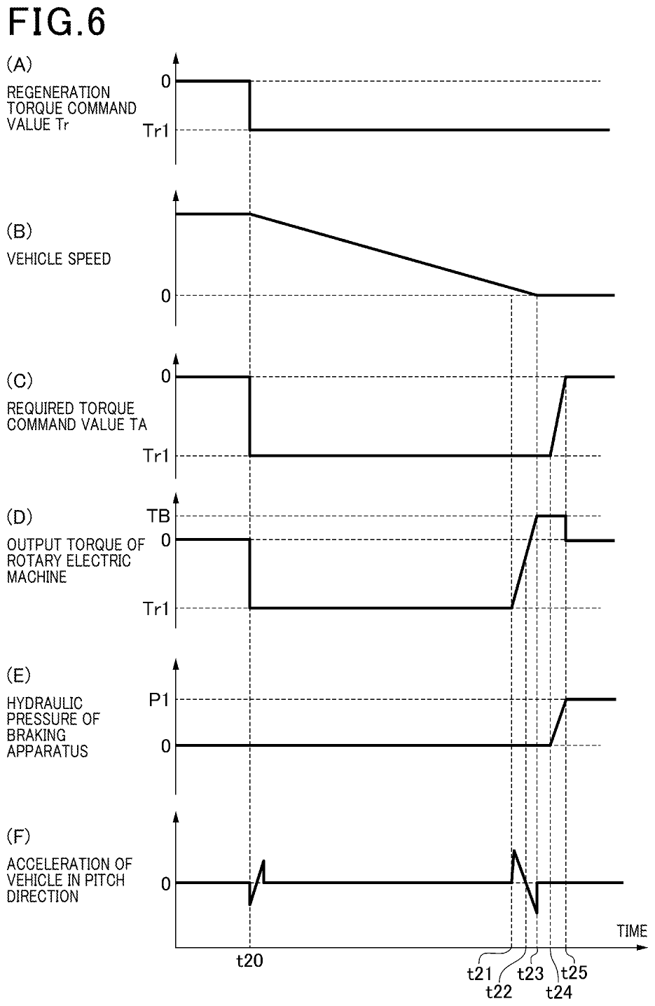

Next, an operation example of the vehicle 100 according to the present embodiment will be described. Hereinafter, a case will be described in which the vehicle 100 travelling on the uphill road stops, as an example. As shown in a timing (A) of FIG. 6, when the brake pedal is depressed at a time t20 for example, the regeneration torque command value Tr transmitted to the control apparatus 10 from the upper-level ECU 30 is set to be the negative predetermined value Tr1. Hereinafter, assuming that the a depression amount of the brake pedal is constant, the regeneration torque command value Tr is maintained at the predetermined value.

The regeneration torque command value Tr is set to be a predetermined value Tr1 at time t20, whereby the required torque command value TA is also set to be the predetermined value Tr1. as shown in the timing (C) of FIG. 6. Thus, as shown in the timing (D) of FIG. 6, the output torque of the rotary electric machine 140 is controlled to be the predetermined value Tr1. That is, since the braking torque having the predetermined value Tr1 is outputted from the rotary electric machine 140, the baking force is applied to the vehicle 100. As a result, the vehicle speed V decreases from the time t20 as shown in the timing (B) of FIG. 6.

Thereafter, when the rotation speed ω of the wheels 111 and 112 is lower than the rotation speed determination value ωs at a time t21, the output torque of the rotary electric machine 140 is controlled along the first torque waveform T1_{MG}. Hence, as shown in the timing (D) of FIG. 6, the torque of the rotary electric machine 130 changes in the positive direction from the predetermined Tr1 after time t21. Thus, the torsion of the power transmission membersgoes back to the previous state. Due to the returning of the torsion of the power transmission members, the vehicle body 101 vibrates in the pitch direction. Specifically, the vehicle body 101 vibrates in the pitch direction from the front side towards the rear side, and then reversely vibrates from the rear side towards the front side. Accordingly, as shown in the timing (F) of FIG. 6, the acceleration of the vehicle 100 in the pitch direction changes to the positive value and then changes towards the negative value. As a result, at time t22, a zero-cross occurs on the acceleration of the vehicle 100 in the pitch direction.

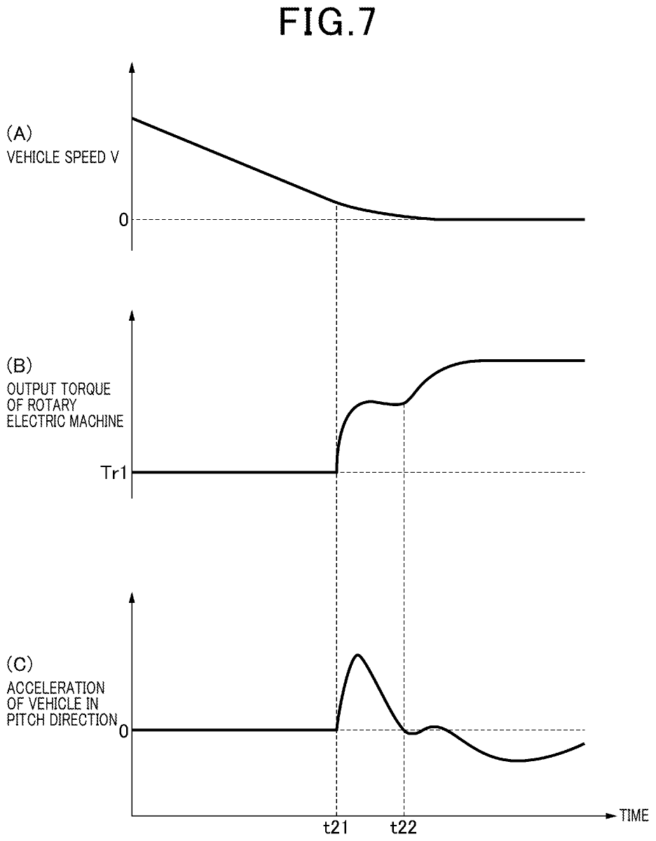

Note that the timings (A) to (C) of FIG. 7 is an enlarged view showing a change in the vehicle speed V, the output torque of the rotary electric machine 140, the acceleration in the pitch direction at a time around time t21 and t22. In the case where the zero-cross occurs on the acceleration of the vehicle 100 in the pitch direction at time t22, the output torque of the rotary electric machine 140 is controlled along the second torque waveform T2_{MG}. Thus, as shown in the timing (B) of FIG. 7, the torque of the rotary electric machine 140 further changes towards the vehicle-stop command value TB after time t22. When the vehicle 100 stops on the uphill road, as shown in the timing (D) of FIG. 6, the vehicle-stop torque command value TB is set to be larger than 0.

As described, a control waveform of the rotary electric machine 140 is changed to the second torque waveform T2_{MG} from the first torque waveform T1_{MG} at a time when a zero-crossing occurs on the acceleration of the vehicle 100 in the pitch direction, that is, at a time when the acceleration of the vehicle 100 in the pitch direction is 0, whereby a speed change of the vehicle 100 in the pitch direction can be smaller. As a result, the vehicle speed can be lowered such that moving speed of the driver's head towards rear direction can be lowered. Accordingly, a ride quality when the vehicle is going to stop can be improved.

Thereafter, as shown in the timing (B) of FIG. 6, when the vehicle-speed V becomes 0 at time t23, as shown in the timing (D) of FIG. 6, the output torque of the rotary electric machine 140 is controlled to be the vehicle-stop torque command value TB. Thus, the vehicle 100 is maintained at the stopped state. In the case where the output torque of the rotary electric machine is continuously maintained at the vehicle-stop torque value TB, the heating value and the power consumption of the rotary electric machine may increase. Hence, according to the present embodiment, as shown in the timing (E) of FIG. 6, the brake ECU 20 controls the hydraulic pressure of the braking apparatuses 121 and 122 to be increased to a predetermined pressure P1 at the time 24 at which a predetermined period elapses from the time 23. The predetermined pressure P1 is set such that a braking force required to maintain the stopped state of the vehicle 100 is applied to the wheels 111 and 112. As shown in the timing (E) of FIG. 6, when the hydraulic pressure of the barking apparatuses 121 and 122 increase to reach the predetermined pressure P1 at time t25, as shown in the timing (D) of FIG. 6, the control apparatus 10 sets the output torque of the rotary electric machine 140 to be 0.

According to the control apparatus 10 of the present embodiment as described above, the following (1) to (6) effects and advantages can be obtained.

(1) The operation control unit 14 controls the output torque of the rotary electric machine 140 to be along the torque waveform when changing the output torque of the rotary electric machine 140 from the required torque command value TA towards the vehicle-stop torque command value TB. The waveform setting unit 13 utilizes, as a torque waveform, a first torque waveform T1_{MG} capable of attenuating a vibration of the vehicle in the pitch direction, and subsequently utilizes a second torque waveform T2_{MG} capable of suppressing a vibration in the power transmission members of the vehicle 100. With this configuration, the output torque of the rotary electric machine 140 is changed along the first torque waveform T1_{MG} capable of attenuating a vibration of the vehicle 100 in the pitch direction, and then changed along the second torque waveform T2_{MG} capable of suppressing a vibration in the power transmission members. Thus, a swinging back in the pitch direction when the vehicle 100 stops is suppressed and then a vibration of the power transmission members is also suppressed. Accordingly, passengers are unlikely to feel discomfort caused by so-called ‘Missing G’ while suppressing the vibration of the vehicle 100 in the pitch direction. Therefore, the vehicle 100 can be appropriately stopped.

(2) The operation control unit 14 starts to control the output torque of the rotary electric machine 140 to be along the torque waveform such that a time when the output torque of the rotary electric machine 140 becomes the vehicle-stop torque command value TB corresponds to a time when the vehicle 100 stops. Specifically, the operation control unit 14 starts to control the output torque of the rotary electric machine 140 to be along the torque waveform when the rotation speed ω of the wheels 111 and 112 is lowered to reach the rotation speed determination value ωs, thereby causing a time when the output torque of the rotary electric machine 140 becomes the vehicle-stop torque command value TB to correspond to a time when the vehicle 100 stops. According to this configuration, when the vehicle 100 stops, since the output torque of the rotary electric machine 140 is at the vehicle-stop torque command value TB, the stopped-state of the vehicle 100 can be reliably maintained.

(3) The operation control unit 14 sets the rotation speed determination value ωs based on the above-described formula f2. That is, the rotation speed determination value ωs is set based on the command torque differential value ΔTᵣ which is a difference value between the required torque command value TA and the vehicle-stop torque command value TB. According to this configuration, the rotation speed determination value ωs can readily be set.

(4) The time constant τ₁ is set to satisfy the above-described formula f4 such that the time constant τ₁ is smaller than the pitch resonant period. The waveform setting unit 13 sets the first torque waveform T1_{MG} to have the time constant τ₁ as indicated by the formula f7. According to this configuration, it is able to prevent the period in which the output torque of the rotary electric machine 140 reaches the vehicle-stop torque command value TB from being excessively long. Hence, it is possible that passengers are unlikely to feel discomfort caused by so-called ‘Missing G’.

(5) The waveform setting unit 13 determines a time for changing the torque waveform from the first torque waveform T1_{MG} to the second torque waveform T2_{MG} based on the actual acceleration of the vehicle 100 in the pitch direction detected by the acceleration sensor 204. Specifically, the waveform setting unit 13 changes the torque waveform from the first torque waveform T1_{MG} to the second torque waveform T2_{MG} based on an occurrence of zero-crossing on the actual acceleration of the vehicle 100 in the pitch direction. According to this configuration, the torque waveform of the rotary electric machine 140 can be changed while suppressing a change in the acceleration of the vehicle 100 in the pitch direction. Hence, a ride quality can be improved.

(6) The waveform setting unit 13 sets the second torque waveform T2_{MG} based on the torque differential value ΔT_{C} and the time constant τ₂ as shown in the above-described formula f9. The torque differential value ΔT_{C} refers to a value in which the vehicle-stop torque command value TB is subtracted from the first torque waveform T1_{MG} at a time when zero-cross is detected on the acceleration of the vehicle 100 in the pitch direction. The time constant τ₂ is set based on the actual measurement value Wₙ of the pitching resonant period of the vehicle 100. According to this configuration, the second torque waveform T2_{MG} can be appropriately set.

The above-described embodiments may be embodied in the following manners.

The process at step S20 shown in FIG. 5 may be executed based on the rotation speed of the rotary electric machine 140 detected by a MG resolver 203. In this case, the rotation speed of the rotary electric machine 140 detected by the MG resolver 203 may be converted to a rotation speed of the wheels 111 using a predetermined formula, whereby a similar determination process can be performed. Further, the rotation speed determination value ωs may be set for the rotation speed of the rotary electric machine detected by the MG resolver 203.

For setting the rotation speed determination value ωs, as long as a time when the output torque of the rotary electric machine 140 becomes the vehicle-stop torque command value TB corresponds to a time when the vehicle 100 stops, a formula different from the above-described formula f2 may be used, The time when the vehicle 100 stops may not be a timing at which the vehicle speed is completely 0. For example, the time when the vehicle 100 stops may be a timing in which an absolute value of the vehicle speed is lower than a predetermined threshold.

The waveform setting unit 13 may change the torque waveform from the first torque waveform T1_{MG} to the second torque waveform T2_{MG} instead of the actual acceleration of the vehicle 100 in the pitch direction, but using a zero-cross of an estimation value of the acceleration of the vehicle 100 in the pitch direction.

The control apparatus 10 and method thereof disclosed in the present disclosure may be accomplished by a one or more dedicated computers each constituted of a processor and a memory programmed to execute one or more functions embodied by computer programs. The control apparatus 10 and method thereof disclosed in the present disclosure may be accomplished by a dedicated computer provided by a processor including one or more dedicated hardware logic circuits. Further, the control apparatus 10 and method thereof disclosed in the present disclosure may be accomplished by one or more dedicated computer where a processor and a memory programmed to execute one or more functions, and a processor including one or more hardware logic circuits are combined, Furthermore, the computer programs may be stored, as instruction codes executed by the computer, into a computer readable non-transitory tangible recording media. The dedicated hardware logic circuits and the hardware logic circuits may be accomplished by a digital circuit including a plurality of logic circuits or an analog circuit.

The present disclosure is not limited to these specific examples. For these specific examples, a person of ordinary skill in the art may appropriately modify the design thereof. These modified designs are included in the scope of the present disclosure as long as features of the present disclosure are provided therein. Further, respective elements included in the above-described specific examples, arrangement, conditions and shapes thereof are not limited to the above-exemplified elements and may be appropriately modified. The respective elements in the above-described specific examples may be appropriately combined as long as no technical inconsistency is present.

### Conclusion

A control apparatus of a first aspect of the present disclosure is a control apparatus of a vehicle to which a rotary electric machine is mounted for a power source of travelling, including an operation control unit that controls an output torque of the rotary electric machine; a first torque command value setting unit that sets a required torque command value as a target value of a torque to be outputted by the rotary electric machine based on a driver's operation applied to the vehicle; a second torque command value setting unit that sets a vehicle-stop torque command value as a target value of a torque to be outputted by the rotary electric machine to maintain a stopped-state of the vehicle when the vehicle stops; and a waveform setting unit that sets a torque waveform indicating a change in the target value of the output torque of the rotary electric machine with respect to time. The operation control unit controls the output torque of the rotary electric machine along the torque waveform when changing the output torque of the rotary electric machine from the required torque command value towards the vehicle-stop torque command value. The waveform setting unit utilizes a first torque waveform and subsequently utilizes a second torque waveform as the torque waveform, the first torque waveform being capable of attenuating a vibration of the vehicle in a pitch direction, the second torque waveform being capable of suppressing a vibration in a power transmission member provided in a power transmission system for transmitting a torque of the rotary electric machine to wheels.

According to this configuration, the output torque of the rotary, electric machine changes along the torque waveform. That is, the output torque of the rotary electric machine changes along the first torque waveform capable of suppressing a swinging back of the vehicle in the pitch direction, and subsequently changes along the second torque waveform capable of suppressing a vibration of the power transmission members of the vehicle. Thus, since a swing back in the pitch direction when vehicle stops is suppressed and then a vibration of the power transmission member is suppressed, passengers are unlikely to feel a discomfort caused by so-called ‘Missing G’ while suppressing the vibration of the vehicle in the pitch direction.

What is claimed is:

1. A control apparatus (10) of a vehicle (100) to which a rotary electric machine (140) is mounted for a power source of travelling, the control apparatus comprising:
an operation control unit (14) that controls an output torque of the rotary electric machine;
a first torque command value setting unit (11) that sets a required torque command value as a target value of a torque to be outputted by the rotary electric machine based on a driver's operation applied to the vehicle;
a second torque command value setting unit (12) that sets a vehicle-stop torque command value as a target value of a torque to be outputted by the rotary electric machine to maintain a stopped-state of the vehicle when the vehicle stops; and
a waveform setting unit (13) that sets a torque waveform indicating a change in the target value of the output torque of the rotary electric machine with respect to time,
wherein
the operation control unit controls the output torque of the rotary electric machine along the torque waveform when changing the output torque of the rotary electric machine from the required torque command value towards the vehicle-stop torque command value; and
the waveform setting unit utilizes a first torque waveform and subsequently utilizes a second torque waveform as the torque waveform, the first torque waveform being capable of attenuating a vibration of the vehicle in a pitch direction, the second torque waveform being capable of suppressing a vibration in a power transmission member provided in a power transmission system for transmitting a torque of the rotary electric machine to wheels.

2. The control apparatus according to claim 1, wherein
the operation control unit starts to control the output torque of the rotary electric machine to be along the torque waveform such that a time when the output torque of the rotary electric machine becomes the vehicle-stop torque command value corresponds to a time when the vehicle stops.

3. The control apparatus according to claim 2, wherein
the operation control unit activates a control of the output torque of the rotary electric machine along the torque waveform when a rotation speed of the wheels decreases to reach a rotation speed determination value, thereby causing a time when the output torque of the rotary electric machine becomes the vehicle-stop torque command value to correspond to a time when the vehicle stops.

4. The control apparatus according to claim 3, wherein
the operation control unit sets the rotation speed determination value based on a difference value between the required torque command value and the vehicle-stop torque command value.

5. The control apparatus according to claim 1, wherein
the waveform setting unit sets the first torque waveform to have smaller time constant than a pitch resonant period of the vehicle.

6. The control apparatus according to claim 1, wherein
the waveform setting unit determines a time for changing the torque waveform from the first torque waveform to the second torque waveform based on an actual acceleration of the vehicle in the pitch direction or an estimation value thereof.

7. The control apparatus according to claim 1, wherein
the waveform setting unit sets the second torque waveform based on a value of the first torque waveform and a pitch resonant period of the vehicle.
